(19) United States
(12) Patent Application Publication
(10) Pub. No.: US 2021/0379701 A1
(43) Pub. Date: Dec. 9, 2021

(54) LASER ENGRAVING USING STOCHASTICALLY GENERATED LASER PULSE LOCATIONS

(71) Applicant: Standex International Corporation, Salem, NH (US)

(72) Inventors: FRANCESCO IORIO, Toronto (CA); IAN ROSS AMELINE, Toronto (CA); TASSO ANASTASIOS KARKANIS, Toronto (CA); MICHAEL WENHAN TAO, Toronto (CA); MASSIMILIANO MORUZZI, Rockford, IL (US); AARON MICHAEL SZYMANSKI, Toronto (CA)

(21) Appl. No.: 17/341,071

(22) Filed: Jun. 7, 2021

Related U.S. Application Data
(60) Provisional application No. 63/036,399, filed on Jun. 8, 2020.

(51) Int. Cl. B23K 26/364; G05B 19/18

(52) U.S. Cl. CPC B23K 26/364; G05B 2219/45163; G05B 19/182

(57) ABSTRACT

A method for laser engraving a three-dimensional pattern into a surface of a workpiece, the method comprising: positioning a laser-engraving head to engrave a first engraving region of the workpiece; and applying a first plurality of laser pulses to a set of first predetermined locations within the first engraving region, wherein the first set of predetermined locations within the first engraving region is based on a probability distribution function that corresponds to a portion of the three-dimensional pattern that is associated with the first engraving region.

### CROSS-REFERENCE TO RELATED APPLICATIONS

This application claims priority benefit of the United States Provisional patent application titled, “STOCHASTIC LASER ENGRAVING,” filed on Jun. 8, 2020 and having Ser. No. 63/036,399. The subject matter of this related application is hereby incorporated herein by reference.

### BACKGROUND

### Field of the Various Embodiments

The various embodiments relate generally to laser engraving and computer science, and, more specifically, to laser engraving using stochastically generated laser pulse locations.

### Description of the Related Art

Laser engraving is a technique used to obtain a specific geometric pattern on a surface of a material via a focused laser beam. By injecting energy onto the surface using a focused laser beam, discrete locations on the surface are heated, and portions of the material are displaced and/or vaporized. Patterned surface geometries formed in this way can render a desired aesthetic texture on the surface and/or create geometric microstructures that alter the material properties of the surface. Laser engraving can be implemented on a wide variety of materials and, therefore, has many useful applications.

To engrave a patterned surface geometry on a workpiece surface, a laser-engraving head is used that includes a mirror positioning system, such as a galvanometer optical scanner, that directs a laser beam with high speed, precision, and repeatability. Typically, the mirror positioning system is configured to scan the laser beam in two different dimensions in order to reach any location within a given engraving region. Because the area of the engraving region that can be addressed and reached by the laser-engraving head is relatively small, laser-engraving an entire workpiece surface usually involves multiple engraving regions and repositioning the laser-engraving head for each of the multiple engraving regions on the workpiece surface. Small inaccuracies in positioning the laser-engraving head at the start of any given engraving region can result in discontinuities in the rows of laser pulses that are used to engrave a workpiece surface. These types of discontinuities can form visible artifacts along the boundaries between the different engraving regions on a workpiece surface, which is highly undesirable. Further, these types of discontinuities are exacerbated when multiple layers of material are removed from the engraving regions, which causes the resultant visual artifacts to be even more noticeable. These types of artifacts are particularly problematic for continuous patterns or surface geometries that do not consist of disconnected components, such as, for example, isolated polka dots or squares, because there are no natural breaks between surface pattern components that help define the boundaries between engraving regions and “hide” any visual artifacts resulting from the laser engraving process.

Currently, to prevent the formation of visual artifacts along the boundary lines between engraving regions on a workpiece surface, the boundaries of each engraving region are repositioned each time a new layer of material is removed in the laser-engraving process. Because the edges of the engraving regions when removing one layer of material are offset from the edges of the engraving regions when removing a subsequent layer of material, removing the subsequent layer of material “overwrites” the boundaries of the different engraving regions, which acts to blur or remove the discontinuities between engraving regions that form visual artifacts.

One drawback of the above approach to blurring or removing the visual artifacts that can result from conventional laser-engraving processes is that, for each layer of material being removed, the laser-engraving head must be repositioned for each engraving region on the workpiece surface. Because dozens of different layers of material are remove in a typical laser-engraving process, and repositioning a laser-engraving head is oftentimes the most time-consuming part of a laser-engraving process, the above approach can substantially increase the processing time for a given workpiece surface.

As the foregoing illustrates, what is needed in the art are more effective ways to implement laser-engraving processes to generate engraved surfaces.

### SUMMARY

A computer-implemented method for laser engraving a three-dimensional pattern into a surface of a workpiece includes: positioning a laser-engraving head to engrave a first engraving region of the workpiece; and applying a first plurality of laser pulses to a set of first predetermined locations within the first engraving region, wherein the first set of predetermined locations within the first engraving region is based on a probability distribution function that corresponds to a portion of the three-dimensional pattern that is associated with the first engraving region.

At least one technical advantage of the disclosed techniques relative to the prior art is that the disclosed techniques, when implemented as part of a laser-engraving process, substantially reduce or prevent visible artifacts along the boundaries between the different engraving regions on a workpiece surface without substantially increasing overall process time. Accordingly, with the disclosed techniques, a workpiece surface can be processed in an amount of time that is similar to the amount time typically associated with laser-engraving a workpiece surface that is not subject to visual artifacts using conventional laser-engraving processes. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a laser-engraving system configured to implement one or more aspects of the various embodiments.

FIG. 2 sets forth a flowchart of method steps for laser engraving a three-dimensional pattern into a surface of a workpiece, according to various embodiments.

FIG. 3 schematically illustrates a plurality of engraving regions on a portion of a workpiece surface, according to various embodiments.

FIG. 4 sets forth a flowchart of method steps for determining the locations of laser pulses when implementing a laser-engraving process, according to various embodiments.

FIG. 5A schematically illustrates a plan view of overlapping engraving regions on a workpiece surface, according to various embodiments

FIG. 5B schematically illustrates a cutaway view of the overlapping engraving regions of FIG. 5A, according to various embodiments.

FIG. 6 illustrates a probability distribution function associated with an overlapping engraving region of FIG. 5A, according to various embodiments.

FIG. 7 is a block diagram of a computing device configured to implement one or more aspects of the various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

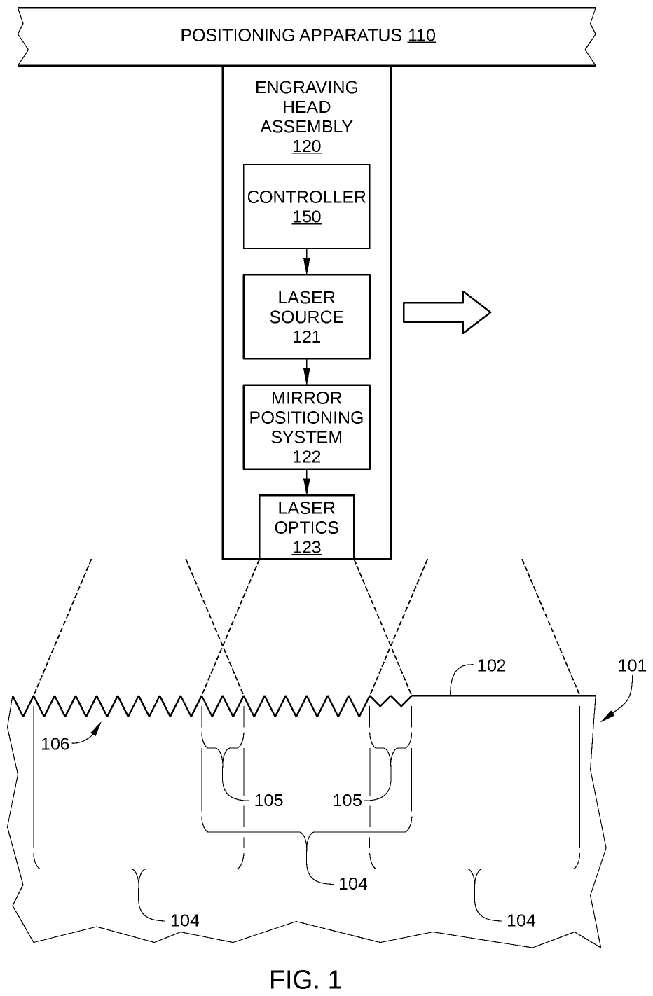

FIG. 1 illustrates a laser-engraving system 100 configured to implement one or more aspects of the various embodiments. In the embodiment illustrated in FIG. 1, laser-engraving system 100 includes an engraving head assembly 120 and a positioning apparatus 110 for positioning engraving head assembly 120 with respect to a surface 102 of a workpiece 101. Positioning apparatus 110 can be any suitable multi-axis position device or assembly that locates and orients engraving head assembly 120 in two or three dimensions with respect to workpiece 101. In operation, positioning apparatus 110 sequentially positions engraving head assembly 120 at different positions over surface 102 of workpiece 101, so that discrete engraving regions 104 can undergo laser engraving and have final pattern 106 formed thereon.

Generally, engraving regions 104 are relatively small compared to surface 102, for example on the order of about 10 cm×10 cm. Consequently, a plurality of engraving regions 104 are typically needed for final pattern 106 to be formed on the intended portions of surface 102. According to various embodiments, engraving regions 104 overlap as shown at overlapped portions 105. In the embodiments, a particular overlapped portion 105 on surface 102 undergoes laser engraving multiple times: once for each engraving region 104 that includes that particular overlapped portion 105. Thus, the laser engraving process associated with each of the multiple engraving regions 104 contributes to the final pattern 106 that is formed in overlapped portion 105.

Engraving head assembly 120 is configured to laser engrave final pattern 106 into surface 102 of workpiece 101. In the embodiment illustrated in FIG. 1, engraving head assembly 120 includes a laser source 121 for generating suitable laser pulses, a mirror positioning system 122 and laser optics 130 to direct the pulses to specific locations within an engraving region 104, and a controller 150.

Controller 150 is configured to enable the operation of engraving head assembly, including controlling the components of engraving head assembly 120 so that laser pulses are directed to the specific locations within an engraving region 104. Thus, in some embodiments, controller 150 implements specific laser source and/or mirror positioning parameters so that a laser pulse of specified size and energy is directed to a specified location. Parameters for the laser source may include laser power, pulse frequency, and/or laser spot size, among others. Parameters for the movement of the laser beam with respect to the surface include engraving speed (e.g., the linear speed at which a laser spot moves across the surface being processed), laser incidence angle with respect to the surface being processed, and/or laser trajectory. In some embodiments, controller 150 is further configured to store predetermined locations for laser pulses within each engraving region 104 and to implement the application of laser pulses to such predetermined locations.

### Laser-Engraving Process Using Stochastically Generated Laser Pulse Locations

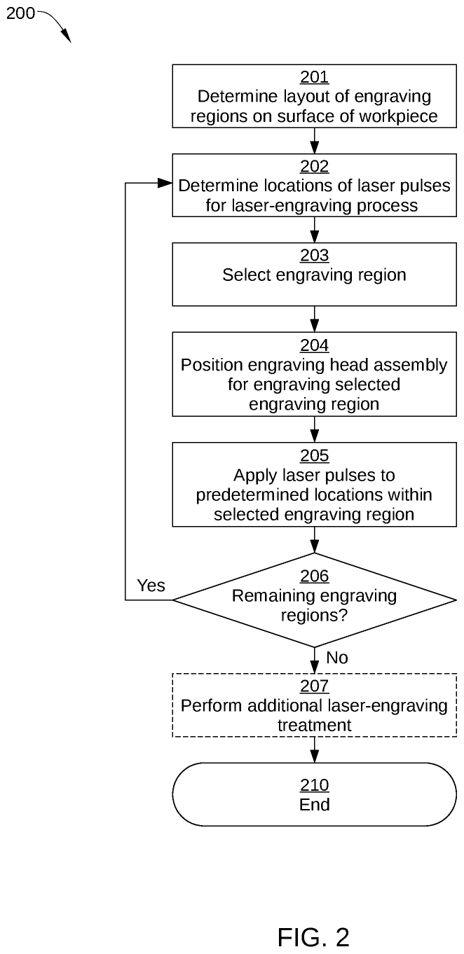

According to various embodiments, a target surface geometry, such as final pattern 106, is generated on surface 102 by applying laser pulses to surface 102 at predetermined locations in each engraving region 104. In the embodiments, the predetermined locations for each particular engraving region 104 are determined based on a probability distribution function that corresponds to the portion of final pattern 106 that is associated with that particular engraving region 104. Specifically, in some embodiments, the predetermined locations for a particular engraving region 104 are determined by performing Monte-Carlo sampling of the probability distribution function for that engraving region until a sufficient number of laser pulse locations are determined that result in final pattern 106 being formed in that particular engraving region 104. Example embodiments are described below in conjunction with FIGS. 2-6.

FIG. 2 sets forth a flowchart of method steps for laser engraving with a three-dimensional pattern into a surface of a workpiece, according to various embodiments. Although the method steps are described in conjunction with the system of FIG. 1, persons skilled in the art will understand that any system configured to perform the method steps, in any order, is within the scope of the embodiments.

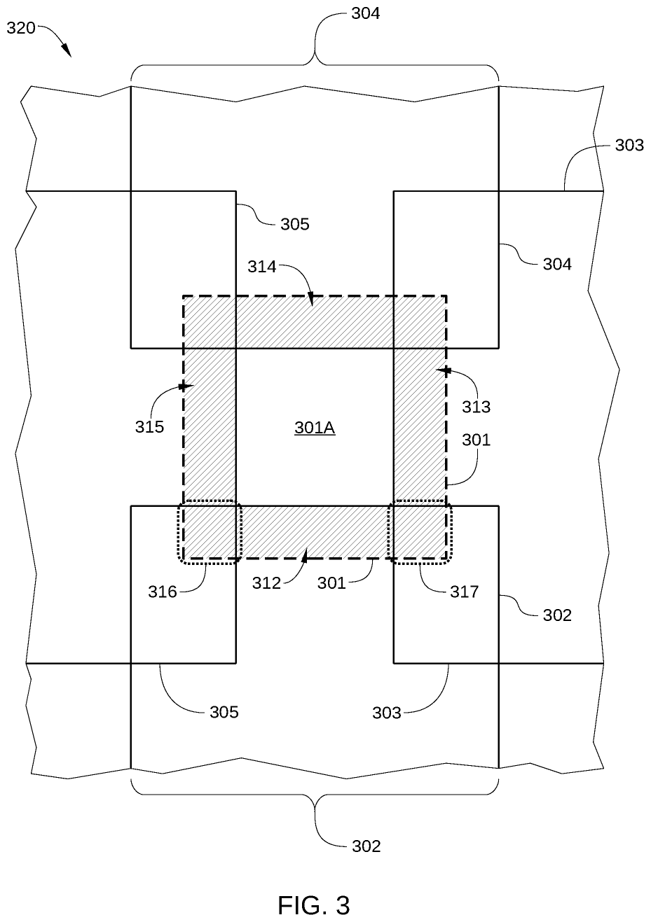

As shown, a method 200 begins at step 201, where a layout of engraving regions 104 on workpiece surface 102 is determined, where surface 102 is to receive a geometric pattern (e.g., final pattern 106) via laser-engraving. Because surface 102 is often a curved, three-dimensional surface, the plurality of engraving regions 104 that are laid out over surface 102 are generally not uniform in size and/or shape. Further, in some embodiments, some or all engraving regions 104 associated with surface 102 include one or more overlapped portions 105 that are also included in other engraving regions 104. In some embodiments, for each engraving region 104, each edge that is adjacent to another engraving region 104 is included in an overlapped portion. One such embodiment is described below in conjunction with FIG. 3.

FIG. 3 schematically illustrates a plurality of engraving regions 301-305 on a portion 320 of a workpiece surface, according to various embodiments. Each of engraving regions 301-305 can be consistent with engraving regions 104 described above in conjunction with FIG. 1. As shown, engraving region 301 (dashed lines) is adjacent to and overlapped by engraving regions 302, 303, 304, and 305. Thus, engraving region 301 shares an overlapped region 312 (cross-hatched) with adjacent engraving region 302, an overlapped region 313 (cross-hatched) with adjacent engraving region 303, an overlapped region 314 (cross-hatched) with adjacent engraving region 304, and an overlapped region 315 (cross-hatched) with adjacent engraving region 305. Thus, in the embodiment illustrated in FIG. 3, each edge of engraving region 301 is included in an overlapped region that is shared with an engraving region that is adjacent to engraving region 301. As a result, a visible edge artifact between engraving region 301 and any of adjacent engraving regions 302, 303, 304 and 305 is less likely to occur.

In the embodiment illustrated in FIG. 3, engraving region 301 includes a non-overlapped portion 301A. As a result, the portion of final pattern 106 (not shown for clarity) that is associated with overlapped portion 301A is formed via a single laser-engraving process—namely, the laser-engraving process that is performed on engraving region 301. By contrast, in other embodiments, some or all engraving regions on a workpiece surface have no non-overlapped portions. Thus, in such embodiments, some or all engraving regions on the workpiece are completely overlapped by one or more other engraving regions.

Further, in embodiments in which engraving region 301 includes one or more overlapped regions, the portion of final pattern 106 that is associated with a particular overlapped portion is formed via multiple laser-engraving processes. Thus, there is a contribution from multiple laser-engraving processes to the formation of the three-dimensional pattern formed on the particular overlapped region. For example, the laser-engraving process associated with engraving region 301 and the laser-engraving process associated with engraving region 302 both contribute to the formation of final pattern 106 in overlapped region 312; the laser-engraving process associated with engraving region 301 and the laser-engraving process associated with engraving region 303 both contribute to the formation of final pattern 106 in overlapped region 313; the laser-engraving process associated with engraving region 301 and the laser-engraving process associated with engraving region 304 both contribute to the formation of final pattern 106 in overlapped region 314; and the laser-engraving process associated with engraving region 301 and the laser-engraving process associated with engraving region 305 both contribute to the formation of final pattern 106 in overlapped region 315. In further examples, the final pattern 106 formed in triply-overlapped region 316 is contributed to by the laser-engraving processes associated with engraving region 301, engraving region 302, and engraving region 305, and the final pattern 106 formed in triply-overlapped region 317 is contributed to by the laser-engraving processes associated with engraving region 301, engraving region 302, and engraving region 303. In other embodiments, portion 320 of a workpiece surface includes one or more overlapped portions (not shown) that are overlapped by a larger number of engraving regions than three.

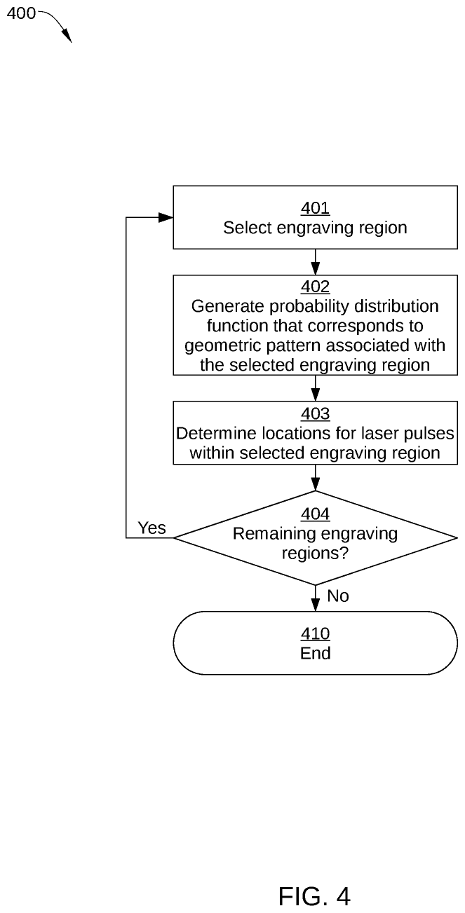

Returning to FIG. 2, in step 202, the locations of laser pulses are determined for a laser-engraving process that generates final pattern 106 on workpiece surface 102. Specifically, the locations of the laser pulses are determined within each engraving region laid out on workpiece surface 102 in step 201. According to various embodiments, the location for each laser pulse in a particular engraving region is determined based on a probability distribution function that corresponds to the portion of final pattern 106 that is associated with that particular engraving region 104. Various embodiments for determining such locations are described below in conjunction with FIG. 4.

In step 203, one of the engraving regions laid out in step 201 is selected. In step 204, engraving head assembly 120 is positioned for laser engraving the selected engraving region. In step 205, laser pulses are applied to the predetermined locations associated with the selected engraving region. Typically, the selected engraving region includes one or more overlapped portions. Consequently, in step 205, laser pulses are applied to locations within each of the one or more overlapped portions. It is noted that, in the one or more overlapped portions of the selected engraving region, additional laser pulses are applied while engraving head assembly 120 is in a different position than when positioned to perform laser engraving on the currently selected engraving region. That is, the additional laser pulses are applied in different iterations of steps 203-206 than the current iteration.

In step 206, the determination is made whether there are any remaining engraving regions on which to perform laser engraving. If yes, method 200 returns to step 203; if no, method 200 proceeds to step 207.

In optional step 207, additional laser-engraving treatment is performed on workpiece surface 102, to further reduce the visual prominence of the edge portions of some or all of the engraving regions laid out on workpiece surface 102. For example, in some embodiments, laser pulses are applied to some or all overlapped areas of each engraving region to further smooth any remaining discontinuities between adjacent engraving regions. In such embodiments, the laser pulses employed in step 207 may be configured so that little or no material is removed from workpiece surface 102 (for example via vaporization), and instead melt certain areas of workpiece surface 102. Method 200 then proceeds to step 210 and terminates.

FIG. 4 sets forth a flowchart of method steps for determining the locations of laser pulses when implementing a laser-engraving process, according to various embodiments. In the embodiments, the laser-engraving process can be consistent with method 200 of FIG. 2, in which a continuous three-dimensional pattern is formed on a surface of a workpiece. In some embodiments, the method steps are performed as part of step 202 of method 200. Although the method steps are described in conjunction with the system of FIG. 1, persons skilled in the art will understand that any system configured to perform the method steps, in any order, is within the scope of the embodiments.

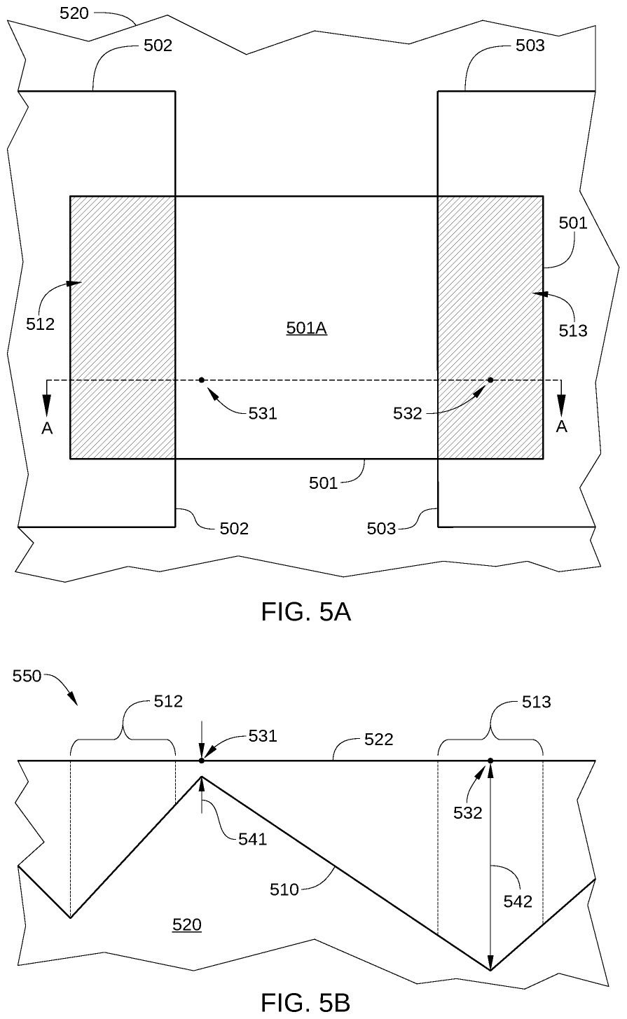

As shown, a method 400 begins at step 401, where an engraving region is selected. The engraving region is selected from a plurality of engraving regions associated with surface 102 of a particular workpiece 101. As such, the selected engraving region is associated with a particular portion of a geometric pattern or other target surface geometry (such as final pattern 106) to be formed on surface 102. In addition, the selected engraving region includes one or more overlapped portions. One embodiment of the selected engraving region is described below in conjunction with FIGS. 5A and 5B.

FIG. 5A schematically illustrates a plan view of overlapping engraving regions 501, 502, and 503 on a surface 522 of a workpiece 520, according to various embodiments, and FIG. 5B schematically illustrates a cutaway view 550 of overlapping engraving regions 501, 502, and 503, according to various embodiments. Cutaway view 550 is taken of workpiece 520 at section A-A in FIG. 5A. As shown, engraving region 502 overlaps engraving region 501 at overlapped portion 512 and engraving region 503 overlaps engraving region 501 at overlapped portion 513. For clarity, engraving regions that overlap other portions of engraving region 501 are omitted in FIG. 5A.

Also shown in FIG. 5B is a profile 510 of the target surface geometry to be formed on surface 522 of workpiece 520 along section A-A. It is noted that the target surface geometry to be formed on surface 522 is generally a three-dimensional surface (e.g., final pattern 106 in FIG. 1), but profile 510 represents the portion of the three-dimensional surface that coincides with section A-A, and therefore is depicted as a one-dimensional function. In general, profile 510 varies in depth from surface 522 in accordance with the target surface geometry to be formed on workpiece 520. Thus, in the embodiment illustrated in FIG. 5B, profile 510 has a depth 541 from surface 522 at a location 531 within engraving region 501 and a depth 542 from surface 522 at a location 532 within engraving region 501.

According to various embodiments described below, in determining locations of laser pulses in a laser-engraving process, a number of laser blasts associated with a particular location within engraving region 501 (e.g., location 531 or location 532) is based at least in part on the depth of profile 510 from surface 522 at that location (e.g., depth 541 or depth 542). During the laser-engraving process, a quantity of material removed from workpiece 522 at a particular location within engraving region 501 is proportional to the number of laser blasts associated with that particular location.

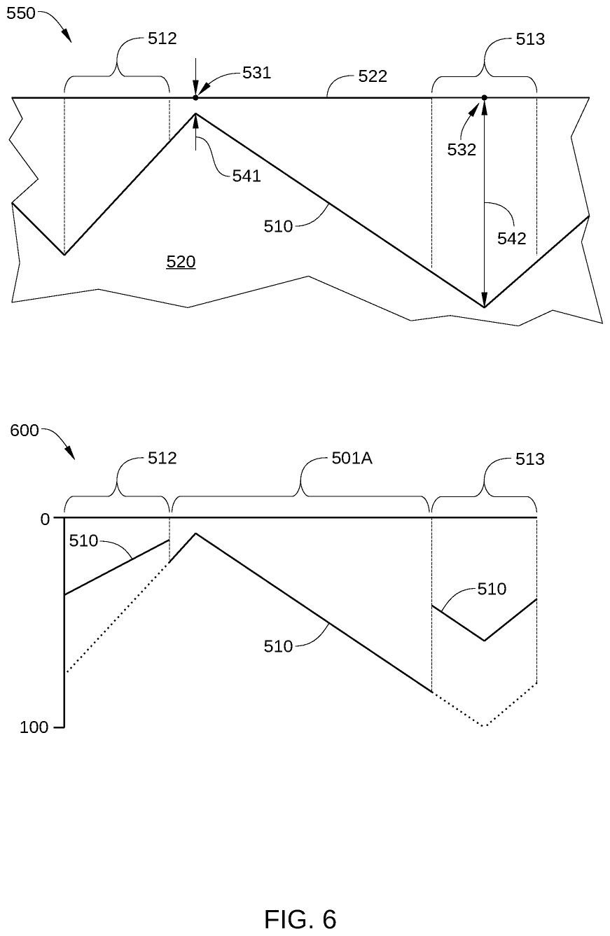

Returning to FIG. 4, in step 402, a three-dimensional probability distribution function is generated for the engraving region selected in step 401, i.e., engraving region 501. According to various embodiments, the probability distribution function generated in step 402 is three-dimensional in that a different value of the probability distribution function is associated with each location within the two-dimensional area associated with engraving region 501. Further, the probability distribution function corresponds to a portion of the three-dimensional pattern that is associated with engraving region 501. More specifically, for a location within engraving region 501 that corresponds to greater material removal (and therefore more laser blasts), the probability distribution function has a greater value, and for a location within engraving region 501 that corresponds to less material removal (and therefore fewer laser blasts), the probability distribution function has a proportionately lower value. One embodiment of such a probability distribution function is described below in conjunction with FIG. 6.

FIG. 6 illustrates a probability distribution function 600 associated with engraving region 501 on workpiece 520, according to various embodiments. For reference, also included in FIG. 6 is cutaway view 550 of FIG. 5B. Similar to profile 510 of the target surface geometry to be formed on surface 522 of workpiece 520, probability distribution function 600 may have a different value for each location within engraving region 501. More specifically, the value of probability distribution function 600 at a particular location within engraving region 501 is based at least in part on the value of profile 510 (e.g., depth from surface 522) at that particular location. Thus, as a depth of profile 510 increases, the value of probability distribution function 600 increases. In some embodiments, a minimum value of probability distribution function 600 is zero, for example at a location in which no material is removed during the laser-engraving process and profile 510 has a depth from surface 522 of 0. Further, in some embodiments, a maximum value of probability distribution function 600 is 1.0 (or 100%), for example at a location in which a maximum quantity of material is removed for the laser-engraving process. In the embodiment illustrated in FIG. 6, depth 542 corresponds to such a maximum quantity of material removal and, as a result, the value of the probability distribution function at location 532 is 1.0 before scaling (as described below).

In some embodiments, in addition to being based at least in part on the value of profile 510 at a particular location within engraving region 501, for locations within an overlapped portion of engraving region 501, the value of probability distribution function 600 is further based on a number of engraving regions that overlap the overlapped portion. Specifically, in such embodiments, the value of probability distribution function 600 in a particular overlapped portion of engraving region 501 is scaled by a number of engraving regions that overlap that particular overlapped portion. For example, in the embodiment illustrated in FIG. 6, overlapped portion 512 is overlapped by two engraving regions on workpiece 520: engraving region 501 and engraving region 502 (as shown in FIG. 5A). Therefore, for locations included in overlapped portion 512, probability distribution function 600 is scaled by a factor of two, i.e., values for probability distribution function 600 are divided by two. Similarly, overlapped portion 513 is overlapped by two engraving regions on workpiece 520: engraving region 501 and engraving region 503 (as shown in FIG. 5A). Therefore, for locations included in overlapped portion 513, probability distribution function 600 is scaled by a factor of two. In instances in which more than two engraving regions overlap a particular overlapped portion, values for probability distribution function 600 are divided by the appropriate whole number.

Returning to FIG. 4, in step 403, locations within engraving region 501 of laser pulses for the laser-engraving process are determined. In some embodiments, the locations are determined based on the probability distribution function 600 for engraving region 501. Specifically, in such embodiments, a sampling of random locations for laser pulses within engraving region 501 is performed, where acceptance of each random location as a location to be used for a laser pulse is determined stochastically, based on the value of probability distribution function 600 associated with that location. Thus, for a random location within engraving region 501 that corresponds to a value of 50%, there is a 50% chance that the random location will be accepted as a location for a laser pulse in the laser-engraving process.

In some embodiments, the above-described location-sampling process is continued for engraving region 501 until a particular integration threshold is reached. For example, in some embodiments, a specific amount of material removal is associated with each laser pulse. Thus, in such embodiments, for each random location that is accepted as a laser pulse location for the laser-engraving process, a suitable quantity of material is estimated to be removed from and/or displaced on workpiece 520, and a corresponding change in the morphology of surface 522 is determined based on such removed and/or displaced material. In such embodiments, the integration threshold may be a loss function between the determined morphology of surface 522 relative to profile 510 of the target surface geometry to be formed on surface 522, such as a root mean square error (RMSE). Therefore, in such embodiments, material is virtually removed from surface 522 in step 403 via the accepted random location samples until the morphology of surface 522 converges with the target surface geometry as represented by profile 510. In such embodiments, the quantity of material estimated to be removed from and/or displaced on workpiece 520 may be determined by a laser pulse simulator configured to translate certain laser source parameters (e.g., laser power, beam diameter, beam trajectory, etc.) into a corresponding quantity of material that is removed from and/or displaced on workpiece 520. Alternatively, the integration threshold for the above-described location-sampling process can be based on a density of samples that is reached for engraving region 501.

Because locations for laser pulses for a particular location within engraving region 501 are accepted based on the value of probability distribution function 600 at the particular location, the number of laser pulses associated with that particular location is proportional to the value of probability distribution function 600. As a result, the resultant energy imparted by the laser pulses to the particular location is also proportional to the value of probability distribution function 600 corresponding to that particular location. Further, because probability distribution function 600 for locations within an overlapped region of engraving region 501 is scaled in some embodiments based on the number of engraving regions that overlap the overlapped portion, in such embodiments, there is a contribution to the resultant energy imparted to the overlapped portion by laser pulses associated with each of the engraving regions that overlap the overlapped portion.

In step 404, the determination is made whether there are remaining engraving regions associated with workpiece 520 for which locations of laser pulses in the laser-engraving process are to be determined. If yes, method 400 returns to step 401; if no, method 400 proceeds to step 410 and terminates.

### Exemplary Computing Device

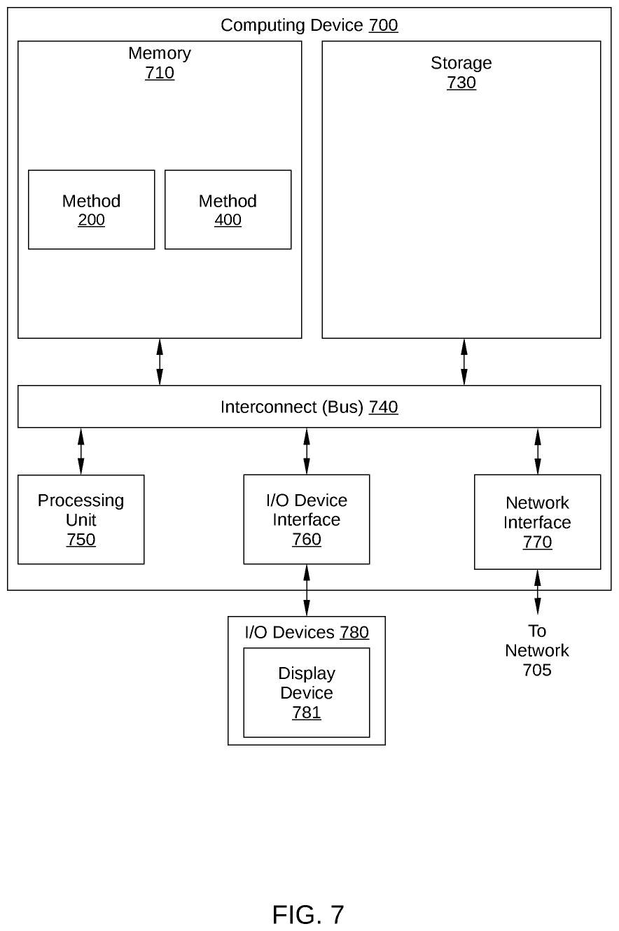

FIG. 7 is a block diagram of a computing device 700 configured to implement one or more aspects of the various embodiments. Thus, computing device 700 can be a computing device associated with laser-engraving system 100 and/or controller 150. Computing device 700 may be a desktop computer, a laptop computer, a tablet computer, or any other type of computing device configured to receive input, process data, generate control signals, and display images. Computing device 700 is configured to perform operations associated with method 200, method 400, and/or other suitable software applications, which can reside in a memory 710. It is noted that the computing device described herein is illustrative and that any other technically feasible configurations fall within the scope of the present disclosure.

As shown, computing device 700 includes, without limitation, an interconnect (bus) 740 that connects a processing unit 750, an input/output (I/O) device interface 760 coupled to input/output (I/O) devices 780, memory 710, a storage 730, and a network interface 770. Processing unit 750 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processing unit 750 may be any technically feasible hardware unit capable of processing data and/or executing software applications, including processes associated with method 200 and/or method 400. Further, in the context of this disclosure, the computing elements shown in computing device 700 may correspond to a physical computing system (e.g., a system in a data center) or may be a virtual computing instance executing within a computing cloud.

I/O devices 780 may include devices capable of providing input, such as a keyboard, a mouse, a touch-sensitive screen, and so forth, as well as devices capable of providing output, such as a display device 781. Additionally, I/O devices 780 may include devices capable of both receiving input and providing output, such as a touchscreen, a universal serial bus (USB) port, and so forth. I/O devices 780 may be configured to receive various types of input from an end-user of computing device 700, and to also provide various types of output to the end-user of computing device 700, such as one or more graphical user interfaces (GUI), displayed digital images, and/or digital videos. In some embodiments, one or more of I/O devices 780 are configured to couple computing device 700 to a network 705.

Memory 710 may include a random access memory (RAM) module, a flash memory unit, or any other type of memory unit or combination thereof. Processing unit 750, I/O device interface 760, and network interface 770 are configured to read data from and write data to memory 710. Memory 710 includes various software programs that can be executed by processor 750 and application data associated with said software programs, including method 200, and/or method 400.

In sum, the various embodiments described herein provide techniques for generating a target surface geometry on a workpiece surface by applying laser pulses to predetermined locations in different engraving regions. In the embodiments, the predetermined locations for each particular engraving region are determined based on a probability distribution function that corresponds to the portion of the target surface geometry that is associated with that particular engraving region. In some embodiments, the predetermined locations for a particular engraving region are determined by performing Monte-Carlo sampling of the probability distribution function for that engraving region until a sufficient number of laser pulse locations are determined that result in the target surface geometry being formed in that particular engraving region.

At least one technical advantage of the disclosed techniques relative to the prior art is that the disclosed techniques prevent visible artifacts along the boundary lines between the different engraving regions on a surface of a laser-engraving workpiece. A further advantage is that the workpiece can be processed in a time interval associated with generating a surface geometry that is not subject to such visual artifacts. These technical advantages provide one or more technological advancements over prior art approaches.

1. In some embodiments, a method for laser engraving a three-dimensional pattern into a surface of a workpiece, the method includes: positioning a laser-engraving head to engrave a first engraving region of the workpiece; and applying a first plurality of laser pulses to a set of first predetermined locations within the first engraving region, wherein the first set of predetermined locations within the first engraving region is based on a probability distribution function that corresponds to a portion of the three-dimensional pattern that is associated with the first engraving region.

2. The method of clause 1, wherein an amount of energy imparted by the first plurality of laser pulses to a particular location within the first engraving region is proportional to a value of the probability distribution function at the particular location.

3. The method of clauses 1 or 2, wherein the engraving region includes at least one overlapped portion that also is included in a second engraving region of the workpiece.

4. The method of any clauses 1-3, wherein, for the overlapped portion, the probability distribution function is scaled by a number of overlapping engraving regions defining the overlapped portion.

5. The method of any clauses 1-4, further comprising: positioning the laser-engraving head to engrave the second engraving region of the workpiece; and applying a second plurality of laser pulses to a second set of predetermined locations within the overlapped region.

6. The method of any clauses 1-5, wherein the second set of predetermined locations is based on a second probability distribution function that corresponds to a portion of the three-dimensional pattern that is associated with the second engraving region.

7. The method of any clauses 1-6, wherein the probability distribution function comprises a three-dimensional probability function.

8. The method of any clauses 1-7, wherein the first engraving region includes at least one non-overlapped portion.

9. A non-transitory computer readable medium storing instructions that, when executed by a processor, cause the processor to perform the steps of: positioning a laser-engraving head to engrave a first engraving region of the workpiece; and applying a first plurality of laser pulses to a set of first predetermined locations within the first engraving region, wherein the first set of predetermined locations within the first engraving region is based on a probability distribution function that corresponds to a portion of the three-dimensional pattern that is associated with the first engraving region.

10. The non-transitory computer readable medium of clause 9, wherein an amount of energy imparted by the first plurality of laser pulses to a particular location within the first engraving region is proportional to a value of the probability distribution function at the particular location.

11. The non-transitory computer readable medium of clauses 9 or 10, wherein the engraving region includes at least one overlapped portion that also is included in a second engraving region of the workpiece.

12. The non-transitory computer readable medium of any clauses 9-11, wherein, for the overlapped portion, the probability distribution function is scaled by a number of overlapping engraving regions defining the overlapped portion.

13. The non-transitory computer readable medium of any clauses 9-12, storing instructions that, when executed by the processor, cause the processor to perform the steps of: positioning the laser-engraving head to engrave the second engraving region of the workpiece; and applying a second plurality of laser pulses to a second set of predetermined locations within the overlapped region.

14. The non-transitory computer readable medium of any clauses 9-13, wherein the second set of predetermined locations is based on a second probability distribution function that corresponds to a portion of the three-dimensional pattern that is associated with the second engraving region.

15. A method for determining locations for laser pulses of a laser engraving process to engrave a three-dimensional pattern into a surface of a workpiece, the method comprising: selecting a first engraving region from a plurality of engraving regions associated with the surface of the workpiece; generating a probability distribution function for the first engraving region of the workpiece, wherein the probability distribution function corresponds to a portion of the three-dimensional pattern that is associated with the first engraving region; and determining a set of locations for a plurality of laser pulses within the first engraving region based on the probability distribution function

16. The method of clause 15, wherein determining the set of locations comprises: sampling a group of random locations within the first engraving region; and accepting a particular location from the group of random locations based on a value of the probability distribution function at the particular location.

17. The method of clauses 15 or 16, wherein sampling the group of random locations within the first engraving region comprises performing a Monte-Carlo sampling procedure.

18. The method of any clauses 15-17, wherein sampling the group of random locations within the first engraving region comprises sampling the group of random locations until material removal associated with locations included in the set of locations is determined to meet an integration threshold.

19. The method of any clauses 15-18, wherein sampling the group of random locations within the first engraving region comprises sampling the group of random locations until imparted energy associated with locations included in the set of locations is determined to meet an integration threshold.

20. The method of any clauses 15-19, wherein the integration threshold comprises a loss function between the portion of the three-dimensional pattern that is associated with the first engraving region and a resultant morphology of the surface after material removal or displacement occurs that is caused by laser pulses being applied to the locations included in the set of locations.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method for laser engraving a three-dimensional pattern into a surface of a workpiece, the method comprising:
positioning a laser-engraving head to engrave a first engraving region of the workpiece; and
applying a first plurality of laser pulses to a set of first predetermined locations within the first engraving region,
wherein the first set of predetermined locations within the first engraving region is based on a probability distribution function that corresponds to a portion of the three-dimensional pattern that is associated with the first engraving region.

2. The method of claim 1, wherein an amount of energy imparted by the first plurality of laser pulses to a particular location within the first engraving region is proportional to a value of the probability distribution function at the particular location.

3. The method of claim 1, wherein the engraving region includes at least one overlapped portion that also is included in a second engraving region of the workpiece.

4. The method of claim 3, wherein, for the overlapped portion, the probability distribution function is scaled by a number of overlapping engraving regions defining the overlapped portion.

5. The method of claim 3, further comprising:
positioning the laser-engraving head to engrave the second engraving region of the workpiece; and
applying a second plurality of laser pulses to a second set of predetermined locations within the overlapped region.

6. The method of claim 5, wherein the second set of predetermined locations is based on a second probability distribution function that corresponds to a portion of the three-dimensional pattern that is associated with the second engraving region.

7. The method of claim 1, wherein the probability distribution function comprises a three-dimensional probability function.

8. The method of claim 1, wherein the first engraving region includes at least one non-overlapped portion.

9. A non-transitory computer readable medium storing instructions that, when executed by a processor, cause the processor to perform the steps of:
positioning a laser-engraving head to engrave a first engraving region of the workpiece; and
applying a first plurality of laser pulses to a set of first predetermined locations within the first engraving region,
wherein the first set of predetermined locations within the first engraving region is based on a probability distribution function that corresponds to a portion of the three-dimensional pattern that is associated with the first engraving region.

10. The non-transitory computer readable medium of claim 9, wherein an amount of energy imparted by the first plurality of laser pulses to a particular location within the first engraving region is proportional to a value of the probability distribution function at the particular location.

11. The non-transitory computer readable medium of claim 9, wherein the engraving region includes at least one overlapped portion that also is included in a second engraving region of the workpiece.

12. The non-transitory computer readable medium of claim 11, wherein, for the overlapped portion, the probability distribution function is scaled by a number of overlapping engraving regions defining the overlapped portion.

13. The non-transitory computer readable medium of claim 11, storing instructions that, when executed by the processor, cause the processor to perform the steps of:
positioning the laser-engraving head to engrave the second engraving region of the workpiece; and
applying a second plurality of laser pulses to a second set of predetermined locations within the overlapped region.

14. The non-transitory computer readable medium of claim 13, wherein the second set of predetermined locations is based on a second probability distribution function that corresponds to a portion of the three-dimensional pattern that is associated with the second engraving region.

15. A method for determining locations for laser pulses of a laser engraving process to engrave a three-dimensional pattern into a surface of a workpiece, the method comprising:
selecting a first engraving region from a plurality of engraving regions associated with the surface of the workpiece;
generating a probability distribution function for the first engraving region of the workpiece, wherein the probability distribution function corresponds to a portion of the three-dimensional pattern that is associated with the first engraving region; and
determining a set of locations for a plurality of laser pulses within the first engraving region based on the probability distribution function

16. The method of claim 15, wherein determining the set of locations comprises:
sampling a group of random locations within the first engraving region; and
accepting a particular location from the group of random locations based on a value of the probability distribution function at the particular location.

17. The method of claim 16, wherein sampling the group of random locations within the first engraving region comprises performing a Monte-Carlo sampling procedure.

18. The method of claim 16, wherein sampling the group of random locations within the first engraving region comprises sampling the group of random locations until material removal associated with locations included in the set of locations is determined to meet an integration threshold.

19. The method of claim 16, wherein sampling the group of random locations within the first engraving region comprises sampling the group of random locations until imparted energy associated with locations included in the set of locations is determined to meet an integration threshold.

20. The method of claim 19, wherein the integration threshold comprises a loss function between the portion of the three-dimensional pattern that is associated with the first engraving region and a resultant morphology of the surface after material removal or displacement occurs that is caused by laser pulses being applied to the locations included in the set of locations.
